(19) United States
(12) Patent Application Publication
(10) Pub. No.: US 2026/0149537 A1
(43) Pub. Date: May 28, 2026

(54) NON-COOPERATIVE MULTI-USER RANGING USING OFDM SIGNALS

(71) Applicant: UNIVERSITY OF SOUTH FLORIDA, Tampa, FL (US)

(72) Inventors: Stavros VAKALIS, Tampa, FL (US); Mehmet YAZGAN, Tampa, FL (US)

(21) Appl. No.: 19/400,990

(22) Filed: Nov. 25, 2025

Related U.S. Application Data
(60) Provisional application No. 63/724,730, filed on Nov. 25, 2024.

(51) Int. Cl. H04L 5/00; H04L 1/00; H04W 4/02

(52) U.S. Cl. CPC H04L 5/0007; H04L 1/0003; H04W 4/025

(57) ABSTRACT

A device may transmit an OFDM symbol phase modulated with a transmitter-specific modulation pattern. A device may receive a received OFDM signal. A device may position a target by processing the received OFDM signal using a matched filter based on the transmitter-specific modulation pattern. A device may output position information for the target based on an output of the matched filter.

### CROSS-REFERENCE TO RELATED APPLICATIONS

This application claims priority to U.S. Provisional Patent Application Ser. No. 63/724,730 filed on Nov. 25, 2024, the entire disclosure of which is incorporated herein by reference.

### BACKGROUND

Wireless sensing systems have historically relied on dedicated radar waveforms that are distinct from communication signals, with Linear Frequency Modulation (LFM) being one of the most widely adopted techniques for range estimation. In a typical LFM-based approach, a transmitted signal exhibits a continuous frequency sweep over a defined bandwidth, producing a chirp waveform that enables distance measurement through correlation of the received echo with a locally generated reference. This method provides relatively high range resolution when large bandwidths are employed; however, the correlation properties of LFM signals introduce limitations in multi-user environments. For example, when multiple LFM transmitters operate within overlapping spectral regions, cross-correlation between chirp sequences may result in ambiguous peaks or ghost targets, thereby degrading accuracy and increasing susceptibility to interference. Additionally, conventional LFM systems often require exclusive time or frequency allocations to mitigate such interference, which constrains scalability and reduces spectral efficiency in dense deployments.

### BRIEF DESCRIPTION OF THE DRAWINGS

FIG. 1A illustrates an environment for multi-user radar sensing using OFDM signals. FIG. 1B illustrates a scenario with vehicular platforms and infrastructure for concurrent radar and communication.

FIG. 2 illustrates a device architecture including transceiver, baseband modules, and control logic for OFDM-based sensing.

FIG. 3 illustrates a signal processing pipeline with receiver front end, SDR modulator, matched filter, and controller for range-Doppler mapping.

FIG. 4 illustrates a flowchart of a method for transmitting OFDM signals, receiving reflections, performing matched filtering, and estimating range and Doppler.

### DETAILED DESCRIPTION

The present disclosure relates to systems, devices, and methods that may utilize orthogonal frequency-division multiplexing (OFDM) signals for radar sensing in conjunction with wireless communication operations within shared spectral resources. In some embodiments, OFDM waveforms employed in communication standards such as but not limited to Wi-Fi or 5G may be phase-modulated with transmitter-specific patterns derived from device identifiers, pseudo-random sequences, or other suitable constructs, thereby enabling concurrent sensing and communication without requiring dedicated radar channels or cooperative signaling among multiple users. Matched-filter processing of reflected OFDM signals may be used to generate range-Doppler maps for target positioning and environmental characterization, and such processing may leverage subcarrier orthogonality to support simultaneous multi-user operation. In further examples, the described approach may be implemented through software-defined radio platforms or integrated within existing communication chipsets, and may be applied in scenarios such as indoor localization, vehicular sensing, infrastructure monitoring, or other sensing applications.

Before any examples of the disclosure are explained in detail, it is to be understood that the disclosure is not limited in its application to the details of construction and the arrangement of components set forth in the following description or illustrated in the following drawings. The disclosure is capable of other examples and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use examples of the disclosure. Various modifications to the illustrated examples will be readily apparent to those skilled in the art, and generic principles presented herein can be applied to other examples and applications without departing from examples of the disclosure. Thus, examples of the disclosure are not intended to be limited to examples shown but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosure. Skilled artisans will recognize the examples provided herein have many useful alternatives and fall within the scope of examples of the disclosure.

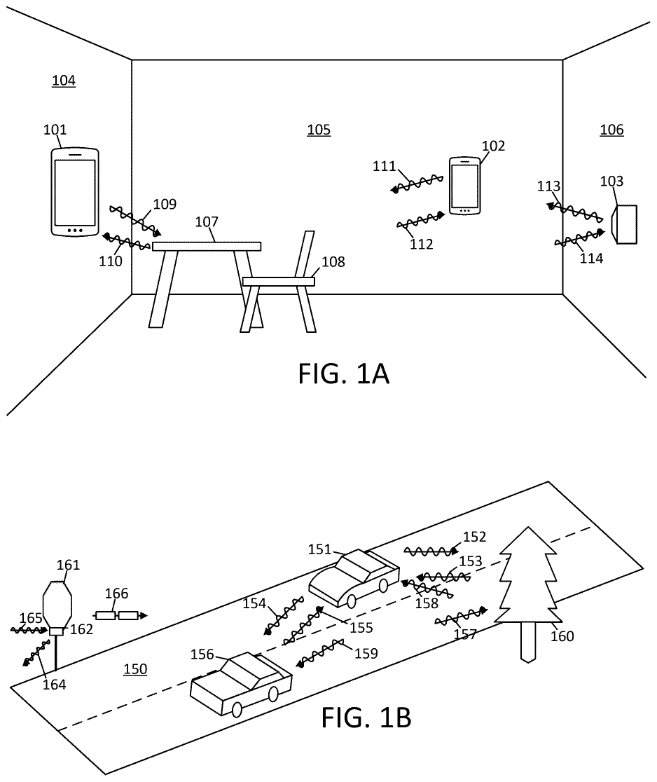

FIG. 1A illustrates an example deployment environment in which multiple devices are situated within a room and operate concurrently using orthogonal frequency-division multiplexing (OFDM) waveforms. The depicted configuration includes typical indoor features such as walls and furniture, and shows a first phone, a second phone, and a wireless communication access point coexisting within a shared communication band. Some or all of these devices may be capable of emitting and receiving OFDM radar signals for purposes such as mapping the surrounding environment and estimating motion through Doppler-based techniques. Although FIG. 1A presents one illustrative indoor scenario, the disclosed technology is broadly applicable to any environment in which OFDM communication modalities are employed, including but not limited to residential spaces, commercial buildings, industrial facilities, vehicular interiors, and outdoor settings. FIG. 1B, described in further detail below, provides an additional example involving traffic-based sensing in a roadway context.

Phone 101 may comprise any suitable communication device, including but not limited to a smartphone, laptop, tablet, wearable device, augmented reality headset, vehicular onboard unit, and so on. In some embodiments, phone 101 may include one or more transceiver subsystems configured to transmit and receive wireless communications using a variety of protocols and modalities, such as but not limited to fifth-generation (5G) cellular networks, Wi-Fi (e.g., IEEE 802.11ac/ax), satellite communication systems, and other wireless standards. Additionally, phone 101 may operate in conjunction with other devices such as phone 102 and access point 103, each of which may share a common communication band and support concurrent operation. The communication functionality of phone 101 may be implemented using one or more radio frequency (RF) chains, antenna arrays, and digital baseband processors, which may be configured to support dynamic switching between communication protocols, simultaneous multi-band operation, and other advanced radio configurations.

In further aspects, phone 101 may be configured to emit OFDM radar signal 109 and receive reflected signal 110, as illustrated in FIG. 1A. These signals may be used to perform non-cooperative environmental sensing within a room or other enclosed space. For example, phone 101 may be positioned within a room defined by walls 104, 105, and 106, and may be located proximate to furniture such as table 107 and chair 108. OFDM radar signal 109 may comprise a symbol including a plurality of modulated orthogonal subcarriers modulated via a phase modulation scheme, such as quadrature amplitude modulation (QAM), and spaced according to a defined subcarrier spacing. Reflected signal 110 may be processed using matched-filter correlation techniques to estimate round-trip time delays and corresponding range values. In some embodiments, phone 101 may utilize the same communication band for both data transmission and radar sensing, leveraging the orthogonality and noise-like characteristics of OFDM signals to suppress cross-user interference. In alternative configurations, phone 101 may employ one communication modality (e.g., 5G) for data exchange and a separate modality (e.g., Wi-Fi or unlicensed spectrum) for radar signaling.

Device 102 may comprise a mobile terminal configured to support wireless communication and radar sensing functionality using OFDM waveforms. The device may include, for example, a smartphone, tablet, wearable device, or other portable or embedded platform capable of transmitting OFDM radar signal 111 and receiving reflected signal 112, as shown in FIG. 1A. The communication capabilities of device 102 may include support for one or more protocols such as but not limited to 5G cellular networks, IEEE 802.11-based Wi-Fi systems, satellite communication links, and global navigation satellite systems (GNSS) such as GPS. In some embodiments, device 102 may perform radar sensing using OFDM transmissions over the same band used for communication, or alternatively, may utilize a separate band or protocol for radar signaling. The radar functionality may be implemented using software-defined radio (SDR) techniques, matched-filter processing, and subcarrier-level modulation diversity, thereby enabling range and Doppler estimation without requiring dedicated radar hardware.

Access point 103 may comprise a wireless access point configured to provide connectivity to one or more client devices using OFDM-based communication protocols. In some embodiments, access point 103 may support IEEE 802.11 standards (e.g., Wi-Fi 6, Wi-Fi 7), 5G New Radio (NR), or other OFDM-compatible protocols. As illustrated in FIG. 1A, access point 103 may emit OFDM radar signal 113 and receive reflected signal 114. The access point may include one or more antenna arrays configured for beamforming, spatial multiplexing, and radar-based environmental sensing. Radar functionality may be integrated into the access point's transmission and reception logic, wherein OFDM transmissions used for communication may also be processed to extract range and velocity information of surrounding objects. In further examples, the access point may transmit OFDM waveforms with known symbol patterns and perform matched-filter correlation with received echoes to characterize the physical environment, detect obstacles, or estimate user positions.

In some embodiments, a plurality of devices, such as but not limited to mobile terminals 101 and 102 and wireless access point 103, may be configured to transmit and receive orthogonal frequency-division multiplexing (OFDM) radar signals concurrently within a shared communication band. The communication band may comprise, for example, a bandwidth of approximately 200 MHz to 800 MHz centered around a carrier frequency such as 3.8 GHz, 3.85 GHz, or other suitable frequencies. As illustrated in FIG. 1A, device 101 may emit OFDM signal 109 and receive reflected signal 110, device 102 may emit OFDM signal 111 and receive reflected signal 112, and access point 103 may emit OFDM signal 113 and receive reflected signal 114. Each of these signals may comprise a plurality of subcarriers modulated using any of a variety of digital modulation schemes, including but not limited to quadrature amplitude modulation (QAM), phase-shift keying (PSK), or other suitable formats. In some examples, different devices may utilize distinct modulation schemes or symbol mappings to facilitate separability in matched-filter processing; however, such variation is not required for operation of the disclosed system. The radar signals may be transmitted and received simultaneously by each device, thereby enabling real-time range and Doppler estimation without reliance on time-division or frequency-division multiplexing. The system may exploit subcarrier orthogonality, independent symbol modulation, and optional carrier frequency offsets to suppress cross-device interference and support multi-user radar sensing within a common spectral and temporal domain.

In further aspects, the OFDM radar signals 109, 111, and 113 may be configured to meet power constraints, spectral masks, and signaling requirements imposed by regulatory standards or protocol specifications, thereby ensuring compatibility with existing communication infrastructure. For example, radar signaling may be constrained to operate within the transmit power limits of Wi-Fi or 5G systems and may conform to spectral emission masks defined by those standards. In some embodiments, the radar signals may be embedded within or derived from communication waveforms, such that the radar functionality is implemented using pilot tones, preambles, or other known symbol structures present in OFDM-based packet transmissions.

In additional embodiments, access point 103 may utilize radar-derived spatial information obtained from analysis of reflected signal 114 to enhance beamforming operations. By analyzing delay and Doppler characteristics of reflected OFDM signals, the access point may infer the location, orientation, and motion of nearby objects or users. This information may be used to optimize transmission paths, reduce multipath interference, and improve channel state estimation. In some examples, access point 103 may perform radar sensing concurrently with data transmission, leveraging the noise-like properties and correlation behavior of OFDM waveforms to extract environmental information without disrupting communication.

Use cases supported by the described system may include, for example, indoor localization, device positioning, occupancy detection, and other sensing-enabled applications. In one embodiment, mobile terminal 102 may estimate its position relative to access point 103 based on analysis of reflected signal 112 and transmit location data via standard communication channels. In another embodiment, mobile terminal 101 may forward raw radar echo data derived from signal 110 to access point 103 for centralized processing. As further examples, access point 103 may aggregate radar data from multiple devices to construct a spatial map of the environment, which may be used for navigation, handoff, adaptive network configuration, etc.

Referring now to FIG. 1B, an exemplary environment is depicted in which multiple entities engage in radar and communication operations using orthogonal frequency-division multiplexing (OFDM) waveforms. The environment includes a roadway 150 upon which a first vehicle 151 and a second vehicle 156 are located. Adjacent to the roadway is a roadside object 160, which may include, for example, a tree, a utility pole, a traffic barrier, a pedestrian, a mailbox, or any other object capable of reflecting radio frequency (RF) signals. Also shown is an infrastructure element 161, which may include, for example, a stop sign, a traffic light, a street lamp, a roadside cabinet, or other fixed installations. Proximate to the infrastructure element is an infrastructure-to-vehicle (12V) communication unit 162, which may be implemented using any suitable wireless communication hardware, such as but not limited to a roadside unit (RSU), a cellular base station, a Wi-Fi access point, a millimeter-wave transceiver, or combinations thereof.

In the illustrated example, the first vehicle 151 emits an OFDM radar signal 152 toward the roadside object 160. The signal 152 reflects off the object and returns as a reflected signal 153. The first vehicle 151 also emits a second OFDM signal 154 directed toward the second vehicle 156, which reflects the signal back as a return signal 155. The second vehicle 156 emits its own OFDM signal 157, which reflects off the first vehicle 151 and returns as signal 159. A portion of the reflected signal 158 from the second vehicle impinges on the first vehicle 151. The impinging signal 158 does not interfere with the radar reception of the first vehicle 151 due to the orthogonality of the OFDM subcarriers and the low cross-correlation between independently modulated OFDM symbols. In some examples, the vehicles may utilize distinct subcarrier allocations, cyclic prefix lengths, or symbol timing offsets to further reduce mutual interference.

The infrastructure unit 162 emits an OFDM radar signal 164 and receives a corresponding reflected signal 165. Additionally, the infrastructure unit 162 transmits an infrastructure-to-vehicle communication signal 166. The communication signal 166 may be implemented using packet-based OFDM transmission and may operate within the same spectral band as the radar signals. For example, the radar and communication signals may coexist within a shared frequency allocation, such as but not limited to 3.8 GHz, 3.85 GHz, 5.9 GHz (DSRC band), 2.4 GHz (Wi-Fi), or other licensed or unlicensed bands. In some examples, the communication packets may include vehicle status information, traffic alerts, cooperative awareness messages (CAM), or decentralized environmental notification messages (DENM), among others.

The wireless modules employed by the vehicles and infrastructure unit may include any combination of transceivers capable of supporting radar and communication functions. Examples of such modules include software-defined radios (SDRs), automotive-grade radar chipsets, 802.11p DSRC radios, 5G New Radio (NR) modems, Wi-Fi 6E transceivers, Bluetooth Low Energy (BLE) modules, ultra-wideband (UWB) radios, and other RF front-end architectures. These modules may support dynamic frequency selection, beamforming, multiple-input multiple-output (MIMO) configurations, and adaptive modulation schemes.

Doppler-based ranging is performed by analyzing the frequency shift of received OFDM signals relative to the transmitted signals. In some examples, Doppler velocity estimation is achieved by measuring phase differences across OFDM subcarriers over successive symbol intervals. The system may employ frequency-domain processing techniques, such as fast Fourier transform (FFT)-based correlation, to extract Doppler shifts and compute relative velocities between entities. Doppler estimation may be performed independently by each vehicle or infrastructure unit without requiring synchronization or coordination with other entities. The Doppler information may be used to determine closing speed, relative motion direction, or acceleration profiles, which may be further utilized for collision avoidance, adaptive cruise control, or traffic flow analysis.

In some embodiments, each OFDM radar signal emitted by a transmitting device—such as devices 101, 102, or 103 in FIG. 1A—may comprise a phase-modulated OFDM symbol that is uniquely configured based on a transmitter-specific modulation pattern. This modulation pattern may be derived from a deterministic or pseudo-random process that incorporates device-specific identifiers, thereby enabling signal separability in matched-filter processing without requiring time-division or frequency-division multiplexing. For example, the modulation pattern may be generated by applying a cryptographic hash function to a device's International Mobile Equipment Identity (IMEI) number, subscriber identity module (SIM) identifier, or media access control (MAC) address. In further examples, the modulation pattern may be assigned by an external entity such as a network controller, access point, or infrastructure node, which may distribute modulation codes during channel setup or device registration. Additional techniques for generating transmitter-specific modulation patterns may include the use of pseudo-random number generators seeded with device-specific entropy sources, lookup tables indexed by device class or manufacturer, or dynamic modulation assignment protocols based on spatial location, time slot allocation, or environmental context. The resulting OFDM symbol may comprise a plurality of subcarriers, each assigned a phase value according to the modulation pattern, such that the composite waveform exhibits noise-like characteristics in the time domain and favorable correlation properties in the frequency domain. As illustrated in FIG. 1A, signal 109 emitted by device 101 and signal 111 emitted by device 102 may each be modulated with distinct transmitter-specific patterns, thereby enabling concurrent radar sensing and communication within a shared spectral band. Similarly, in FIG. 1B, signals 152, 154, and 157 may be configured with transmitter-specific modulation patterns to facilitate multi-vehicle radar operation and infrastructure-to-vehicle sensing without mutual interference.

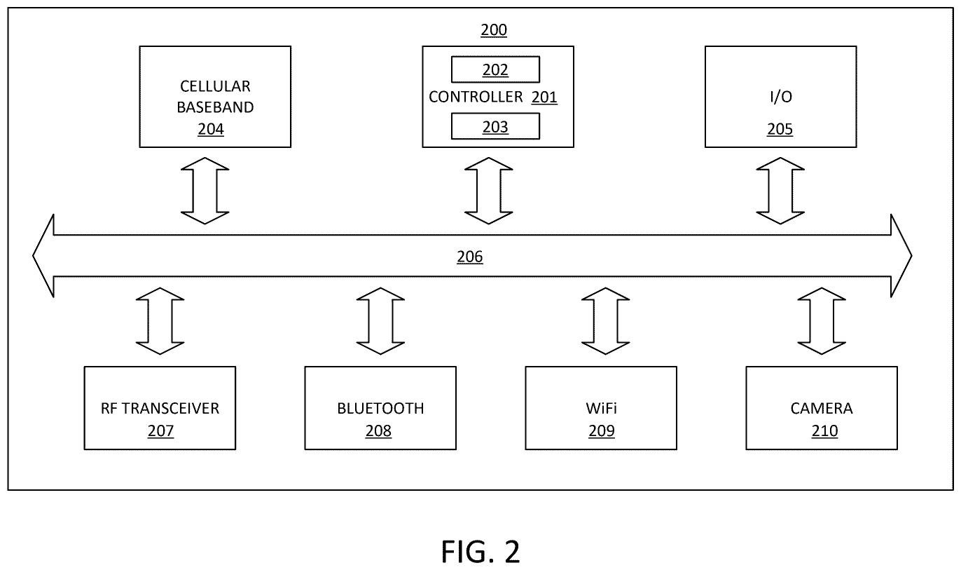

Referring now to FIG. 2, a block diagram is presented illustrating an exemplary embodiment of a device 200 that may be configured to support multi-user radar ranging using orthogonal frequency-division multiplexing (OFDM) signals. It should be understood that the configuration of device 200 is presented solely for illustrative purposes and is not intended to be limiting. In various embodiments, device 200 may be implemented in any suitable form factor or platform, including but not limited to a cellular handset, tablet, wearable device, vehicular unit, unmanned aerial system, fixed infrastructure node, or other communication-capable apparatus, etc.

Device 200 includes a microcontroller 201, which comprises a processor 202 and a non-transitory computer-readable medium 203. The processor 202 may include, for example, a central processing unit (CPU), digital signal processor (DSP), field-programmable gate array (FPGA), neural processing unit (NPU), application-specific integrated circuit (ASIC), system-on-chip (SoC), or any combination thereof. The non-transitory computer-readable medium 203 may include one or more memory technologies, such as static random-access memory (SRAM), dynamic random-access memory (DRAM), flash memory, magnetoresistive RAM (MRAM), phase-change memory (PCM), or other suitable storage media, etc. In some embodiments, the processor 202 may be configured to execute instructions stored in medium 203 to perform OFDM waveform generation, matched-filter correlation, Doppler estimation, and transmitter-specific modulation pattern assignment. Additionally, the processor 202 may execute firmware routines implementing RAT protocol stacks, including but not limited to scheduling algorithms, authentication procedures, and handover control, while software layers may manage RAT signaling, modulation schemes, and adaptive resource allocation for simultaneous radar and communication operations.

Cellular baseband circuitry 204 may be configured to support one or more wireless communication protocols, including but not limited to Long-Term Evolution (LTE), New Radio (NR), Code Division Multiple Access (CDMA), Global System for Mobile Communications (GSM), or other 3GPP-compliant standards, etc. The baseband circuitry 204 may include components such as baseband processors, digital front-end (DFE) modules, turbo decoders, channel encoders, modulation/demodulation engines, and timing recovery circuits, etc. In some embodiments, the baseband circuitry 204 may be configured to emit OFDM radar signals using existing communication waveforms. Firmware associated with the baseband circuitry may implement RAT-specific physical layer procedures, such as channel estimation, hybrid automatic repeat request (HARQ) handling, and carrier aggregation, while higher-layer software may provide protocol stack management, mobility control, and RAT interworking functions.

Input/output (I/O) circuitry 205 may be configured to manage peripheral interfaces and user interaction components. The I/O circuitry 205 may include, for example, display controllers, touchscreen digitizers, audio codecs, microphone amplifiers, speaker drivers, universal serial bus (USB) interfaces, serial peripheral interfaces (SPI), general-purpose input/output (GPIO) pins, and other suitable I/O subsystems, etc. In some embodiments, the I/O circuitry 205 may facilitate user-initiated radar sensing operations, data visualization, or integration with external sensors and actuators.

Internal interconnect 206 may comprise one or more buses or communication links configured to facilitate data exchange among the various components of device 200. The interconnect 206 may be implemented using any suitable bus architecture, such as Advanced extensible Interface (AXI), Advanced High-performance Bus (AHB), Peripheral Component Interconnect Express (PCIe), Serial Peripheral Interface (SPI), Inter-Integrated Circuit (I2C), or other standardized or proprietary interconnect protocols, etc. The interconnect 206 may be realized as a single physical bus or as multiple logically linked buses, and may support synchronous or asynchronous data transfer. In some embodiments, firmware-level arbitration mechanisms, software drivers, etc. may be employed to prioritize radar sensing data streams and associated traffic flows across shared interconnect resources, for example to maintain phase locking between sequential OFDM pulses.

An RF transceiver 207 is provided to perform radio frequency upconversion and downconversion of OFDM signals. The RF transceiver 207 may include components such as mixers, voltage-controlled oscillators (VCOs), phase-locked loops (PLLs), low-noise amplifiers (LNAs), power amplifiers (PAS), bandpass filters, and analog-to-digital/digital-to-analog converters (ADC/DAC), etc. In some embodiments, the RF transceiver 207 may operate over carrier frequencies such as 1.5 GHz, 3.8 GHz, 5.9 GHz, or other suitable bands, and may support subcarrier spacing (e.g., 12.5 MHz) and bandwidths (e.g., 200 MHz to 800 MHz) appropriate for high-resolution radar sensing. Firmware associated with the RF transceiver may implement RAT-specific frequency hopping, adaptive modulation, and transmit power control, while software modules may manage dynamic spectrum allocation and coexistence strategies for multi-band operation.

In some embodiments, the cellular baseband circuitry 204, in cooperation with the processor 202 and the RF transceiver 207, may be configured to transmit a sequence of multiple OFDM symbols forming a coherent pulse train during a defined coherent processing interval (CPI). Each symbol within the sequence maintains phase continuity by referencing timing and frequency resources associated with the device 200 architecture, thereby enabling Doppler estimation through slow-time frequency analysis. The number of symbols, denoted as M, may vary according to application requirements and may include, for example, values in the range of approximately 16 to 128 or more symbols per CPI. Increasing M enhances velocity resolution and improves signal-to-noise ratio by permitting integration of correlation outputs across multiple symbols; however, larger M values correspondingly extend the CPI duration and may influence system latency.

Bluetooth module 208 may be configured to support short-range wireless communication protocols, such as Bluetooth Classic, Bluetooth Low Energy (BLE), Bluetooth 5.x, or other suitable standards, etc. The module 208 may include baseband processors, RF front-end components, antenna interfaces, and protocol stacks for device pairing, data exchange, and low-power operation. Firmware and software may further implement RAT coexistence algorithms to mitigate interference between Bluetooth and cellular RAT operations.

Wi-Fi module 209 may be configured to support wireless local area network (WLAN) protocols, such as IEEE 802.11a/b/g/n/ac/ax, or other suitable standards, etc. The module 209 may include media access control (MAC) processors, baseband engines, RF transceivers, and antenna interfaces. In some embodiments, the Wi-Fi module 209 may be configured to emit OFDM radar signals within the 2.4 GHz or 5 GHz bands, enabling indoor mapping, proximity detection, or motion estimation using matched-filter correlation techniques. Firmware and software layers may implement RAT interworking functions, channel bonding, and adaptive beamforming for enhanced radar and communication performance.

Camera 210 may be configured to capture visual imagery and may include components such as image sensors (e.g., complementary metal-oxide-semiconductor (CMOS) or charge-coupled device (CCD)), lens assemblies, image signal processors (ISPs), infrared filters, and optical stabilization mechanisms, etc.

In further aspects, device 200 may be configured to emit OFDM radar signals comprising transmitter-specific modulation patterns derived from device identifiers, such as but not limited to International Mobile Equipment Identity (IMEI) numbers, Subscriber Identity Module (SIM) credentials, Media Access Control (MAC) addresses, or other unique identifiers, etc. These patterns may be generated using deterministic or pseudo-random algorithms, including cryptographic hash functions, seeded pseudo-random number generators, or lookup tables indexed by device class or manufacturer. The resulting OFDM symbols may exhibit noise-like characteristics in the time domain and favorable correlation properties in the frequency domain, thereby enabling signal separability in multi-user environments without requiring time-division or frequency-division multiplexing.

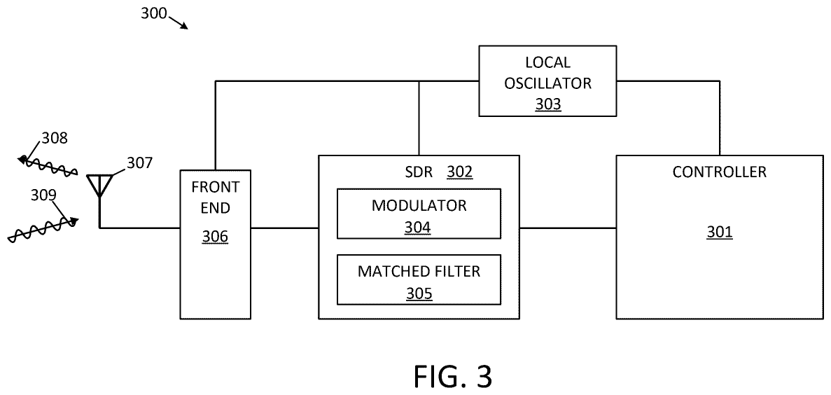

FIG. 3 illustrates a pipeline for an example device 300 configured to implement multi-user radar sensing utilizing OFDM signaling. In some embodiments, the transmitted signal may be encoded using a modulator that is also employed for generating communication packets in accordance with OFDM-based protocols. Implementations of the system may be employed with respect to any of multiple suitable standards that use OFDM, such as but not limited to Fifth Generation (5G) cellular, Sixth Generation (6G) wireless systems, IEEE 802.11 Wi-Fi, Digital Video Broadcasting (DVB) standards, Long-Term Evolution (LTE), etc.

The system may comprise a controller 301, such as described with respect to controller 201 of FIG. 2. The controller 301 may control, implement, or coordinate the other system components. Additionally, in some examples, the controller 301 may be configured to generate a transmitter-specific pattern that is applied to the OFDM signal emitted by the system 300. This transmitter-specific pattern may be derived from any suitable sources, for example, as a pseudo-random number generated internally by the controller 301, as a deterministic value obtained from a secure entropy source, or as a parameter received from an external entity through a communication interface. In some aspects, the controller 301 may implement logic to map the transmitter-specific pattern onto subcarrier indices within the OFDM symbol structure, such as discrete Fourier transform (DFT)-based operations to embed the pattern into the frequency domain representation of the OFDM waveform.

In further embodiments, the controller 301 may configure the matched filter block 305 to enable correlation between a received OFDM signal 309 and a reference representation of the transmitted OFDM signal 308 that incorporates the transmitter-specific pattern. The configuration process may include generating a correlation template that reflects the spectral distribution and phase characteristics of the transmitted waveform, wherein the transmitter-specific pattern is embedded across multiple OFDM subcarriers in accordance with the modulation scheme applied by the modulator block 304. In some aspects, the modulation scheme may employ Quadrature Amplitude Modulation (QAM), which provides both amplitude and phase components for each subcarrier symbol. Accordingly, the controller 301 may utilize these amplitude and phase values, derived from the QAM constellation points, to construct a reference signal that accurately represents the transmitted waveform. The controller 301 may determine filter parameters corresponding to the encoded transmitter-specific sequence and mapping its phase offsets and amplitude scaling factors to corresponding subcarrier indices, thereby ensuring that the correlation template accounts for both dimensions of the QAM-modulated signal. These coefficients may be stored in memory accessible to the matched filter block 305 and subsequently applied during convolution or correlation operations to identify the time delay associated with the reflected signal, which corresponds to the range of the target. Additionally, the controller 301 may update the matched filter configuration dynamically when a new transmitter-specific pattern is generated, for example, as a pseudo-random sequence or as a value received from an external source.

In some embodiments, the controller 301 may configure the matched filter block 305 to enable correlation between a received OFDM signal 309 and a reference representation of the transmitted OFDM signal 308 that incorporates the transmitter-specific pattern. The configuration process may include generating a correlation template that reflects the spectral distribution and phase characteristics of the transmitted waveform, wherein the transmitter-specific pattern is embedded across multiple OFDM subcarriers in accordance with the modulation scheme applied by the modulator block 304. In some aspects, the modulation scheme may employ Quadrature Amplitude Modulation (QAM), which provides amplitude and phase components for each subcarrier symbol, and these values are utilized by the controller 301 to construct a reference signal that accurately represents the transmitted waveform.

In some embodiments, to aid in the explanation of matched-filter ranging using orthogonal frequency-division multiplexing (OFDM) signals, the transmitted baseband OFDM signal may be represented as:

$$s ( t ) = {\sum }_{n = 0}^{N - 1} {A}_{n} {e}^{j {ϕ}_{n}} {e}^{j 2 π n Δ ft}$$

where Aₙ and φₙ denote amplitude and phase terms for the n^{th} subcarrier, N is the total number of subcarriers, and Δf is the subcarrier spacing. The received signal after reflection from a target at range R can be expressed as:

$$r ( t ) = {\sum }_{n = 0}^{N - 1} {α}_{n} {A}_{n} {e}^{j {ϕ}_{n}} {e}^{j 2 π n Δ f ( t - τ )} + w ( t )$$

$$τ = \frac{2 R}{c}$$

where αₙ represents the complex channel coefficient, w(t) is additive noise, and corresponds to the round-trip propagation delay with c being the speed of light. A matched filter is applied to maximize the signal-to-noise ratio (SNR) by computing the correlation integral:

$$x ( τ ) = {\int }_{- T}^{T} s ⋆ ( t - τ ) r ( t ) dt$$

where s*(t−τ) denotes the complex conjugate of the delayed transmitted signal. The delay estimate \hat{τ} is obtained by locating the argument that maximizes |x(τ)|, and the corresponding range estimate is given by:

$$\hat{R} = \frac{c \hat{τ}}{2}$$

In some embodiments, the received signal at a first user, denoted as r₁(t), may comprise multiple components corresponding to reflections of signals transmitted by both the first user and at least one other user. For example, the received signal may include echoes of the first user's transmitted signal from multiple targets as well as echoes of signals transmitted by a second user, such that:

$${r}_{1} ( t ) = {s}_{11} ( t ) + {s}_{12} ( t ) + {s}_{21} ( t ) + {s}_{22} ( t )$$

where s₁₁(t) and s₁₂(t) represent reflections of the first user's transmitted signal from Target-1 and Target-2, respectively, and s₂₁(t) and s₂₂(t) represent reflections of the second user's transmitted signal from Target-1 and Target-2, respectively. In the matched filtering process performed by the first user, each term in the received signal r₁(t) may be cross-correlated with the transmitted signal s₁(t) of the first user to determine the propagation delay associated with each reflection.

For purposes of clarification, the cross-correlation between the first user's transmitted signal s₁(t) and its reflection from Target-1, denoted as s₁₁(t), may be considered first. Subsequently, the cross-correlation between the first user's transmitted signal s₁(t) and the echo of the second user's transmitted signal from Target-1, denoted as s₂₁(t), may be expressed. In this respect, each user may transmit an Orthogonal Frequency-Division Multiplexing (OFDM) signal comprising N subcarriers, such that the baseband OFDM signals for the first and second users may be represented as:

$${s}_{1} ( t ) = {\sum }_{n = 0}^{N - 1} {A}_{n 1} {e}^{j 2 π {f}_{n 1} t} , {s}_{2} ( t ) = {\sum }_{n = 0}^{N - 1} {A}_{n 2} {e}^{j 2 π {f}_{n 2} t}$$

where Aₙ₁ and Aₙ₂ denote modulation symbols, such as but not limited to Quadrature Amplitude Modulation (QAM) symbols, transmitted on the n-th subcarrier by the first and second users, respectively, and fₙ₁ and fₙ₂ denote the corresponding subcarrier frequencies. In some aspects, the subcarrier frequencies of the second user may differ from those of the first user by a frequency offset f_{off}, such that fₙ₂=fₙ₁+f_{off}. This frequency offset, combined with the orthogonality of OFDM subcarriers and the independence of modulation symbols, may reduce cross-user interference during correlation operations. For instance, such a frequency offset may be introduced by process or other minor variations in each systems local oscillator or other clock source 303.

The correlation operation for determining range may be expressed as:

$${C}_{11} ( τ ) = {\int }_{- ∞}^{∞} {s}_{1}^{*} ( t - τ ) {s}_{11} ( t ) dt$$

where s₁(t) denotes the transmitted OFDM signal and s₁₁(t) represents the reflected signal from a target, and τ corresponds to the propagation delay.

Expanding the transmitted signal representation, the baseband OFDM waveform may be expressed as:

$${s}_{1} ( t ) = {\sum }_{n = 0}^{N - 1} {A}_{n} {e}^{j 2 π {f}_{n} t}$$

where Aₙ denotes the QAM symbol amplitude and phase for subcarrier n, and fₙ represents the subcarrier frequency. Substituting this into the correlation integral yields:

$${C}_{11} ( τ ) = {\int }_{- ∞}^{∞} ( {\sum }_{{n}_{1} = 0}^{N - 1} {A}_{{n}_{1}}^{*} {e}^{- j 2 π {f}_{{n}_{1}} ( t - τ )} ) ( {\sum }_{{n}_{1} = 0}^{N - 1} {A}_{{n}_{1}} {e}^{j 2 π {f}_{{n}_{1}} t} ) dt$$

This expands further to:

$${C}_{11} ( τ ) = {\sum }_{{n}_{1} = 0}^{N - 1} {A}_{{n}_{1}} {A}_{{n}_{1}}^{*} {\int }_{- ∞}^{∞} {e}^{j 2 π ( {f}_{{n}_{1}} t - {f}_{{n}_{1}} ( t - τ ) )} dt$$

Since fₙ₁=fₙ₁ for the same subcarrier, the integral simplifies to a delta function proportional to δ(τ−τ₁₁), where τ₁₁ corresponds to the round-trip delay related to the target range. This produces a sharp correlation peak at the correct range of Target-1 to User-1.

In multi-user scenarios, another term in the received signal of User-1 is the echo of the Tx2 signal from Target-1, denoted as s₂₁(t). The cross-correlation between s₂₁(t) and the Tx1 signal can be computed as:

$${C}_{21} ( τ ) = {\int }_{- ∞}^{∞} {s}_{1}^{*} ( t - τ ) {s}_{21} ( t ) dt$$

Substituting the expressions for s₂₁(t) and s₁(t) yields:

$${C}_{21} ( τ ) = {\sum }_{{n}_{2} = 0}^{N - 1} {\sum }_{{n}_{1} = 0}^{N - 1} {A}_{{n}_{1}}^{*} {A}_{{n}_{2}} {\int }_{- ∞}^{∞} {e}^{j 2 π ( {f}_{{n}_{2}} t - {f}_{{n}_{1}} ( t - τ ) )} dt$$

Due to the different phase and amplitude patterns between users, the subcarriers are quasi-orthogonal, and the integral of their cross-products yields a much weaker response than the autocorrelation response.

In some alternative implementations, the controller 301 or the software-defined radio (SDR) 302 may be configured to select a subset of available OFDM subcarrier frequencies at random for transmission and correlation purposes. By limiting the active subcarriers to a randomly chosen subset, the system can reduce spectral overlap with other devices operating in the same environment. When multiple systems independently select different random subsets of subcarriers, the resulting cross-correlation response between their respective signals becomes significantly weaker than in cases where identical or overlapping subcarrier sets are used. This reduction in correlation amplitude further mitigates interference and enhances multi-user isolation. In other implementations, the controller 301 may utilize all available subcarriers whenever possible, or as many subcarriers as permitted by system constraints, to maximize signal energy and improve ranging accuracy.

The controller 301 may store the computed filter coefficients in memory accessible to the matched filter block 305 and apply them during convolution or correlation operations to identify the time delay associated with the reflected signal, which corresponds to the range of the target. Additionally, the controller 301 may update the matched filter configuration dynamically when a new transmitter-specific pattern is generated, for example, as a pseudo-random sequence or as a value received from an external source.

In some embodiments, the system may include an RF front end 306 operatively coupled to an antenna 307, wherein the RF front end 306 comprises circuitry for up-conversion and down-conversion of radio frequency signals, impedance matching components, and filtering elements configured to maintain signal integrity during transmission and reception. The antenna 307 may be any suitable radiating structure, such as but not limited to a monopole, dipole, patch, or phased array, and may be adapted to operate across frequency bands compatible with Orthogonal Frequency-Division Multiplexing (OFDM) signaling schemes. The antenna 307 is configured to radiate an outgoing OFDM signal 308 generated by the software-defined radio (SDR) 302 and to receive an incoming OFDM signal 309 reflected from one or more targets within the environment.

In further aspects, the outgoing OFDM signal 308 may comprise a plurality of subcarriers modulated according to a selected modulation scheme, such as but not limited to Quadrature Amplitude Modulation (QAM), wherein the subcarriers may embed transmitter-specific phase patterns or codewords for identification and correlation purposes. The incoming OFDM signal 309 may include echoes of the transmitted waveform as well as signals originating from other systems operating in the same spectral region, and the RF front end 306 may down-convert these signals to an intermediate frequency or baseband for subsequent processing by the SDR 302.

Additionally, the SDR 302 may incorporate a modulator block 304 and a matched filter block 305 configured to operate in a manner that enables simultaneous transmission and reception of OFDM signals. In some implementations, the modulator block 304 may function as a modulator-demodulator unit, wherein the same hardware resources are employed for both modulation and demodulation of communication signals. Even in systems that are nominally half-duplex, the SDR 302 may execute control logic that permits concurrent operation of the modulator and matched filter, thereby supporting simultaneous radar signaling modes without requiring separate transmit and receive chains.

In some embodiments, the processing pipeline illustrated in FIG. 3 may implement range-Doppler mapping using operations distributed across controller 301, modulator block 304, matched filter block 305, RF front end 306, and associated signal paths 308 and 309. For example, modulator block 304 may generate a sequence of OFDM symbols during a coherent processing interval (CPI), each symbol comprising N subcarriers spaced by Δf and phase-modulated with transmitter-specific patterns. RF front end 306 may transmit these symbols as outgoing OFDM signal 308 and receive echoes from targets as incoming OFDM signal 309. The received signal may be expressed as:

$${r}_{i} ( t ) = {\sum }_{n = 1}^{N} {α}_{i , n} {A}_{i , n} {e}^{j 2 π ( n {Δ}_{f} ) ( t - {τ}_{i 1} )} {e}^{j 2 π ( n {Δ}_{f} ) {f}_{d} ( t - {τ}_{i 2} )} + {\sum }_{n = 1}^{N} {α}_{( i + 1 ) , n} {A}_{( i + 1 ) , n} {e}^{j 2 π ( n ( {Δ}_{f} + {f}_{off} ) ) ( t - {τ}_{( i + 1 ) 1} )} {e}^{j 2 π ( n ( {Δ}_{f} + {f}_{off} ) ) {f}_{d} ( t - {τ}_{( i + 1 ) 2} )}$$

where α_{i,n} and α_{(i+1),n} denote complex reflection coefficients, τᵢ₁ and τᵢ₂ represent round-trip delays, and f_{d} is the Doppler frequency shift computed as:

$${f}_{d} = \frac{2 {f}_{c} v}{c}$$

with f_{c} being the carrier frequency and c the speed of light. In some examples, controller 301 may store these parameters for subsequent processing.

Matched filter block 305 may correlate the incoming OFDM signal 309 with a reference template corresponding to the transmitted waveform, producing outputs organized into a two-dimensional array where columns represent fast-time samples and rows represent slow-time indices across M OFDM symbols. Controller 301 may then compute the frequency-domain correlation according to:

$${X}_{i} ( f ) = {S}_{i}^{†} ( f ) {R}_{i} ( f )$$

where Sᵢ(f) denotes the transmit signal spectrum and Rᵢ(f) denotes the received signal spectrum, and the dagger indicates Hermitian conjugation. Controller 301 may apply an inverse FFT along the fast-time axis to obtain range profiles and a discrete Fourier transform along the slow-time axis to estimate Doppler frequency components.

The estimated Doppler frequency \hat{f}_{d} may be converted to radial velocity using:

$$\hat{v} = \frac{c {\hat{ω}}_{d}}{2 {ω}_{c}} = \frac{c {\hat{f}}_{d}}{2 {f}_{c}}$$

where \hat{ω}_{d} is the angular Doppler frequency and ω_{c} is the carrier angular frequency.

The resulting range-Doppler map may present range along one axis and radial velocity along another, enabling identification of stationary and moving targets. Stationary objects may appear at or near zero Doppler frequency, whereas moving objects may exhibit frequency shifts proportional to their radial velocity. Range resolution may be determined by the OFDM bandwidth according to:

$${Δ}_{R} = \frac{c}{2 \cdot BW}$$

and velocity resolution may depend on observation time and carrier frequency. In further examples, controller 301 may implement FFT and inverse FFT routines on a digital signal processing engine.

In some embodiments, the range-Doppler map generated by controller 301 may be presented or utilized in a variety of ways, such as but not limited to graphical visualization on a display device as a two-dimensional heat map with range bins along one axis and Doppler frequency or radial velocity bins along another axis, wherein amplitude or correlation magnitude may be represented by color gradients, contour lines, or other visual indicators; three-dimensional surface plots or volumetric renderings for enhanced spatial interpretation; tabular or matrix-based data structures for export to external analytics engines; or compressed representations for transmission over wired or wireless networks for remote monitoring, archival storage, or distributed processing. In further examples, the range-Doppler map may serve as an input to automated systems including, but not limited to, collision-avoidance modules in vehicular platforms, occupancy detection algorithms in building automation systems, gesture-recognition engines in consumer electronics, robotics navigation frameworks, and industrial automation controllers, wherein the map may be combined with additional sensor modalities such as LiDAR, ultrasonic sensors, or camera-based vision systems to enable sensor fusion and improve situational awareness. Additionally, the map may be employed in predictive modeling routines for traffic flow estimation, adaptive thresholding for security applications, or machine-learning pipelines for object classification and tracking, etc. These examples are non-limiting, and other configurations, variations, and uses may be implemented without departing from the scope of the described embodiments.

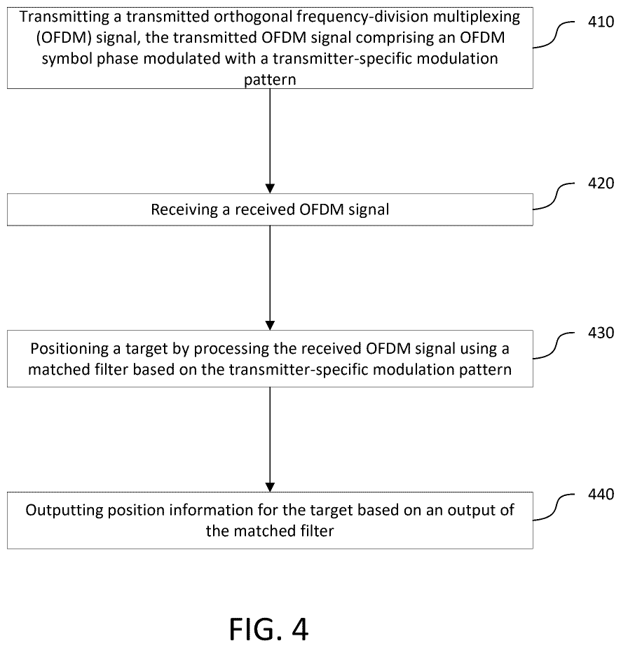

FIG. 4 illustrates a flowchart of an example method for performing multi-user radar sensing using orthogonal frequency-division multiplexing (OFDM) signals. The method may be implemented by any suitable device or system, such as but not limited to a mobile terminal, access point, vehicular unit, or infrastructure node, and may be executed using hardware and software components including a controller, software-defined radio (SDR), modulator, matched filter, and RF front end.

At step 410, the method includes transmitting an OFDM symbol phase-modulated with a transmitter-specific modulation pattern. In some embodiments, the transmitter-specific modulation pattern may be derived from device identifiers such as International Mobile Equipment Identity (IMEI) numbers, Subscriber Identity Module (SIM) credentials, or Media Access Control (MAC) addresses, and may be generated using deterministic or pseudo-random algorithms including cryptographic hash functions or seeded pseudo-random number generators. The modulation pattern may be mapped onto subcarrier indices within the OFDM symbol structure using discrete Fourier transform (DFT)-based operations, and the OFDM symbol may employ a modulation scheme such as Quadrature Amplitude Modulation (QAM) to provide amplitude and phase components for each subcarrier. In further examples, the transmitted OFDM signal may comprise a sequence of coherent OFDM symbols phase-modulated with the transmitter-specific modulation pattern during a coherent processing interval (CPI), thereby enabling range-Doppler estimation. Additionally, the transmitted signal may be generated by a modulator using a common local oscillator with the matched filter, and may be emitted via an RF front end coupled to an antenna configured for operation across OFDM-compatible frequency bands.

In some embodiments, the system may operate within an established communication network that implements standardized resource allocation procedures, such as time-division multiple access (TDMA). In certain examples, the radar sensing functionality may be integrated into the communication protocol by utilizing scheduled transmission opportunities (e.g., time slots) assigned during network access procedures. For instance, a device may acquire a slot through conventional random-access or scheduling request mechanisms defined by the radio access technology (RAT), such as those employed in 5G New Radio (NR) or IEEE 802.11 protocols, and subsequently transmit one or more orthogonal frequency-division multiplexing (OFDM) symbols or a coherent sequence of OFDM symbols during the allocated slot, thereby maintaining compliance with medium access control (MAC) layer constraints. In further aspects, the system may alternatively coexist with communication traffic on a shared spectral band without engaging in protocol-defined slot acquisition or scheduling mechanisms. For example, the system may transmit OFDM symbols independently of any coexisting communications, opportunistically during intervals permitted under media access rules applicable to unlicensed bands, such as listen-before-talk (LBT) or carrier-sense multiple access with collision avoidance (CSMA/CA), etc. At step 420, the method includes receiving a received OFDM signal. The received signal may comprise echoes of the transmitted waveform reflected from one or more targets, as well as signals originating from other devices operating in the same spectral region. The RF front end may down-convert the received signal to an intermediate frequency or baseband for subsequent processing by the SDR. In some embodiments, the same communications chipset used for transmission may also be employed for reception and processing of the received OFDM signal, thereby enabling integration of radar and communication functions within a common hardware platform.

At step 430, the method includes positioning a target by processing the received OFDM signal using a matched filter based on the transmitter-specific modulation pattern. The matched filter may be implemented as a software-defined matched filter configured to correlate the incoming OFDM signal with a reference template corresponding to the transmitted waveform. The correlation template may reflect the spectral distribution and phase characteristics of the transmitted signal, including the transmitter-specific modulation pattern embedded across multiple OFDM subcarriers. Filter coefficients may be computed based on the amplitude and phase values of the QAM-modulated subcarriers and stored in memory accessible to the matched filter block. During correlation operations, the matched filter may produce outputs organized into a two-dimensional array representing fast-time and slow-time samples, which may be further processed using fast Fourier transform (FFT) and inverse FFT routines to obtain range profiles and Doppler frequency estimates.

At step 440, the method includes outputting position information for the target based on an output of the matched filter. In some embodiments, the position information may comprise a range-Doppler map presenting range along one axis and radial velocity along another, wherein amplitude or correlation magnitude may be represented by color gradients, contour lines, or other visual indicators. The range-Doppler map may be utilized in various applications, such as but not limited to collision avoidance, occupancy detection, gesture recognition, or spatial mapping, and may be displayed locally or transmitted to external systems for further analysis. Additional processing steps may include windowing, zero-padding, clutter suppression, and adaptive thresholding to improve resolution and mitigate interference.

Alternative implementations may employ random subcarrier selection to reduce spectral overlap with other devices, dynamic modulation assignment protocols based on environmental context, or integration with communication waveforms to enable simultaneous radar and data transmission within shared spectral bands. These variations are non-limiting and may be combined or modified without departing from the scope of the described method.

It should be noted that the methods described herein describe possible implementations. The operations and the steps may be rearranged, or otherwise modified and other implementations are possible. Further, aspects from two or more of the methods may be combined.

The various illustrative blocks and components described in connection with the disclosure herein may be implemented or performed using a general-purpose processor, a DSP, an ASIC, a Central Processing Unit (CPU), a graphics processing unit (GPU), a neural processing unit (NPU), a Field Programmable Gate Array (FPGA) or other PLD, a quantum processor, a discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, a combination of classical and quantum processors, or any other such configuration). Any functions or operations described herein as being capable of being performed by a processor may be performed by multiple processors that, individually or collectively, are capable of performing the described functions or operations.

The functions described herein may be implemented using hardware, software executed by one or more processors, firmware, or any combination thereof. If implemented using software executed by multiple processors, the functions may be stored as or transmitted using one or more instructions or code of a computer-readable medium. Other examples and implementations are within the scope of the disclosure and appended claims. For example, due to the nature of software, functions described herein may be implemented using software executed by one or more processors, hardware, controllers, firmware, hardwiring, circuitry, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer, whether classical or quantum. By way of example, and not limitation, non-transitory computer-readable media may include random access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection may be properly termed a computer-readable medium. For example, the software may be transmitted from a website, server, or other remote source using a wired technology such as a coaxial cable, fiber optic cable, twisted pair, digital subscriber line (DSL), universal serial bus (USB), high-definition multimedia interface (HDMI), video graphics array (VGA), digital visual interface (DVI), thunderbolt cable, power cable, ribbon cable, integrated services digital network (ISDN), or wireless technologies such as wireless fidelity (Wi-Fi), Bluetooth, cellular network, near-field communication (NFC), Zigbee, long range (LoRa), infrared (IR), radio frequency identification (RFID), light fidelity (Li-Fi), satellite, ultra-wideband (UWB), millimeter wave (mmWave), and microwave. The wired and or wireless technologies are included in the definition of computer-readable medium. Disk and disc, as used herein, include a compact disk (CD), laser disc, optical disc, digital versatile disc (DVD), floppy disk, and Blu-ray disc. Disks or discs may reproduce data magnetically or optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “computing” may refer to any operations that may be performed by a computer (or a computing device), including (but not limited to): computation, data storage, data retrieval, communication, execution of an algorithm, and the like. Further, as used herein, a “computing device” may refer to any device in which a computing operation may be carried out. A computing device may be, for example (but not limited to): a compute component, a storage component, a network device, a telecommunications component, and the like.

As used herein, the term “computing resource” may refer to any program, application, document, asset, executable program file, desktop environment, computing environment, network environment, or other resource made available to, for example, a user of a computing device. A computing resource may be delivered to a computing device via, for example (but not limited to): conventional installation, a method of streaming, a virtual machine executing on a remote computing device, execution from a removable storage device connected to the computing device (e.g., a universal serial bus (USB) device), and the like.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. As used herein, outputting at least one signal may refer to any type of signal that may be output, including wireless communication signals, electrical signals, or any other type of signal that may be transferred by voltages, currents, electromagnetic waves, magnetic fields or particles, optical fields or particles, or any combination thereof. As used herein, “communication” may refer to data transferring or passing, or may refer to two or more components coordinating a job or task. As used herein, the term “data” is intended to be broad in scope. In this manner, that term “data” embraces, for example, (but not limited to): a data stream (or stream data), data chunks, data blocks, atomic data, objects of any type, files of any type (e.g., media files, spreadsheet files, database files, etc.), directories, sub-directories, volumes, and the like.

Although the disclosure may describe components and functions that may be implemented in a particular example with reference to a particular standard or protocol, the disclosure is not limited to the standard or protocol. Other standards or protocols supporting similar functionality are considered equivalents thereof.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Furthermore, “and/or” as used in a list of items indicates an inclusive list such that, for example, a list of at least one of A, B, and/or C means A or B or C or AB or AC or BC or ABC (i.e., A and B and C). Also, as used herein, the phrase “based on” shall not be construed as a reference to a closed set of conditions. For example, an example step that may be described as “based on condition A” may be based on both a condition A and a condition B. For example, as used herein, the phrase “based on” shall be construed in the same manner as the phrase “based at least in part on.”

As used herein, including in the claims, the article “a” before a noun may be open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” may refer to any or all of the one or more components. For example, referring to “the one or more components” subsequently in the claims may be understood to be equivalent to referring to “at least one of the one or more components.”

The terms “determine,” “determining,” “identify,” or “identifying” encompasses a variety of actions and, therefore, “determining” or “identifying” can include calculating, computing, processing, deriving, investigating, looking up (such as via looking up in a table, a database, or another data structure), receiving, ascertaining, and the like. Also, “determining” or “identifying” can include receiving (for example, receiving information), accessing (for example, accessing data stored in memory), retrieving, and the like. Also, “determining” or “identifying” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label may be used in the specification, the description may be applicable to any one of the similar components having the same first reference label irrespective of the second reference label or other subsequent reference label.

The description set forth herein, in connection with the appended figures, describes example configurations and does not represent all the examples that may be implemented or that are within the scope of the claims. The term “example” or “instance” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples. The features of the various examples described herein may be combined in any suitable manner. It is contemplated that one or more features from one example may be incorporated into another example unless explicitly stated otherwise. The combinations of features from different examples are within the scope of the disclosure.

Although terms such as “document,” “file,” “segment,” “block,” or “object” may be used by way of example, the present disclosure is not limited to any particular form of representing and storing data or other information. Rather, the present disclosure may be equally applicable to any object capable of representing information.

It will be appreciated by those skilled in the art that while the disclosure has been described above in connection with particular examples, the disclosure is not necessarily so limited, and that numerous other examples, uses, means for, modifications and departures from the examples, uses, and means for are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

What is claimed is:

1. A method, comprising:
transmitting an receive orthogonal frequency-division multiplexing (OFDM) symbol phase modulated with a transmitter-specific modulation pattern;
receiving a received OFDM signal;
positioning a target by processing the received OFDM signal using a matched filter based on the transmitter-specific modulation pattern; and
outputting position information for the target based on an output of the matched filter.

2. The method of claim 1, further comprising transmitting a sequence of coherent OFDM symbols phase modulated with the transmitter-specific modulation pattern.

3. The method of claim 1, further comprising:
generating the transmitted OFDM symbol with a modulator using a common local oscillator with the matched filter.

4. The method of claim 1, wherein the matched filter comprises a software-defined matched filter.

5. The method of claim 1, further comprising:
generating and transmitting the transmitted OFDM symbol using a communications chipset.

6. The method of claim 5, further comprising:
receiving and processing the received OFDM signal using the communications chipset.

7. The method of claim 1, wherein the position information comprises a range-Doppler map.

8. The method of claim 1, wherein the transmitter-specific modulation pattern comprises a transmitter-specific bit sequence and the OFDM symbol is generated using a communication protocol modulation and coding scheme.

9. A non-transitory computer-readable medium storing instructions that are executable to perform operations comprising:
transmitting an orthogonal frequency-division multiplexing (OFDM) symbol phase-modulated with a transmitter-specific modulation pattern;
receiving a reflected OFDM signal corresponding to the transmitted OFDM signal;
processing the received OFDM signal using a matched filter configured based on the transmitter-specific modulation pattern to generate correlation outputs; and
outputting position information for a target based on the correlation outputs.

10. A device comprising:
a transceiver to transmit and receive orthogonal frequency-division multiplexing (OFDM) signals;
a modulator to generate an OFDM symbol phase-modulated with a transmitter-specific modulation pattern;
a matched filter to process a received OFDM signal based on the transmitter-specific modulation pattern;
a processor coupled to the transceiver, the modulator, and the matched filter; and
a non-transitory computer-readable medium storing instructions that, when executed by the processor, cause the processor to:
control transmission of the OFDM symbol via the transceiver;
process correlation outputs from the matched filter to determine position information for a target; and
output the position information.
